(19) United States
(12) Patent Application Publication
(10) Pub. No.: US 2026/0357897 A1
(43) Pub. Date: Nov. 12, 2026

(54) OIL RING FOR A PISTON, AND PISTON ASSEMBLY

(71) Applicant: Cummins Inc., Columbus (IN)

(72) Inventors: Aakash Gupta, Columbus, IN (US); Nilaya Sumadhur Abhyankar, Columbus, IN (US); Craig Hetisimer, Columbus, IN (US)

(21) Appl. No.: 19/489,765

(22) PCT Filed: May 22, 2024
(86) PCT No.: PCT/US2024/030501

§ 371 Date: Dec. 3, 2025

Related U.S. Application Data
(60) Provisional application No. 63/509,084, filed on Jun. 20, 2023.

(51) Int. Cl. F16J 9/06; F02F 5/00; F16J 9/20

(52) U.S. Cl. CPC F16J 9/062; F02F 5/00; F16J 9/206

(57) ABSTRACT

An oil ring for an internal combustion engine is provided. The oil ring includes an oil ring body having an outer side and inner side. The oil ring also includes an expander having an outer surface. The outer surface of the expander contacts the inner side of the oil ring body to expand the oil ring body. An oil drain gap is formed between the outer surface of the expander and the inner side of the oil ring body.

### CROSS-REFERENCE TO RELATED APPLICATION:

The present application claims priority to, and the benefit of the filing date of, U.S. Provisional App. Ser. No. 63/509,084 filed on Jun. 20, 2023, which is incorporated herein by reference.

### TECHNICAL FIELD

The present application relates generally to internal combustion engines, and more particularly, to an oil ring for use with a piston and piston assembly of an internal combustion engine.

### BACKGROUND

Pistons for internal combustion engines move up and down or side-to-side in a cylinder during engine operation. Pistons include one or more piston rings that extend around the piston between the piston and a cylinder bore wall. Pistons used in internal combustion engines usually include one or two piston rings and at least one oil ring per piston for scraping excess oil from the cylinder bore wall. The excess oil flows through the oil ring and down the piston to the crankcase.

The oil ring generally includes two components such as, for example, an oil ring main body and a coil expander. The coil expander is provided to bias the oil ring main body outward in a radial direction from the piston groove containing the oil ring against the cylinder bore wall. Forcing the oil ring main body against the cylinder bore wall facilitates scraping excess oil.

The oil ring main body includes an upper projection and a lower projection with a middle portion therebetween that defines an outer periphery of the oil ring main body adjacent the cylinder bore wall. An outer surface of the upper and lower projections slide against the cylinder bore wall as the piston reciprocates. The middle portion of the oil ring main body also includes a plurality of oil drain holes that extend from the outer periphery to an inner periphery of the oil ring main body. The plurality of oil drain holes allows scraped oil to pass from the outer periphery into the space behind the oil ring, where the oil drains from the groove containing the oil ring to an oil pan at the underside of the piston.

Current industry trends suggest utilization of oil rings with thinner axial heights to enable lower friction and improved oil consumption targets. However, assembling these thinner height (i.e., low tension) oil rings involve challenges to maintain production cycle times due to assemble-ability issues. Design alternatives currently available in the market that aid in assembly comes with risks of excess oil blockage and can lead to high oil consumption issues.

Therefore, further improvements in this technology area are needed to address these issues, among others.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as would occur to one skilled in the art.

### SUMMARY

The present disclosure includes an oil ring for a piston of an internal combustion engine. In one embodiment, the oil ring includes an oil ring body having a cross section viewed in an axial direction. The cross section has an outer side and inner side, and the oil ring body includes at least one drain hole extending between the outer side and the inner side. The oil ring also includes an expander having an outer surface. The outer surface of the coil expander contacts the inner side of the oil ring body at first and second contact locations to expand the coil ring body. An oil drain gap is formed between the outer side of the expander and the inner side of the oil ring body that extends from the first contact location to the second contact location. The oil drain gap includes trough portion that intersects the at least one drain hole.

In an embodiment, a piston assembly for an internal combustion engine is provided. The piston assembly includes a piston including a plurality of annular grooves. At least one piston ring is located in one of the plurality of grooves, and oil ring is provided in another one of the plurality of grooves. The oil ring includes an oil ring body having an inner side facing the piston and an opposite outer side. The oil ring body includes at least one drain hole extending between the inner side and the outer side. An expander includes outer surface in contact with the inner side of the oil ring body to radially expand the oil ring body. The outer surface of the expander contacts the oil ring body at first contact location and at second contact location, and second contact location is circumferentially spaced from the first contact location. Oil drain gap is formed between the inner side of the oil ring body and the outer surface of the expander. The oil drain gap extends from the first contact location to the second contact location. The inner side of the oil ring body includes a channel around inner side that intersects the at least one drain hole and forms trough portion of the oil drain gap.

This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

The description herein makes reference to the accompanying drawings wherein like numerals refer to like parts throughout the several views, and wherein:

FIG. 1 is a schematic view of a cylinder of an internal combustion engine that houses a piston assembly according to the present disclosure.

FIG. 2 is a schematic view of an oil ring according to an example embodiment of the present disclosure.

FIG. 3 is a sectional view of a part of a piston with the oil ring of FIG. 2 positioned in a groove thereof.

FIG. 4 is an axial section view of the oil ring of FIG. 2.

FIG. 5 is a detailed view the oil drain gap of the oil ring of FIG. 4.

FIG. 6 is a detail view of one of the contact locations between the expander and the oil ring body of the oil ring of FIG. 4.

### DETAILED DESCRIPTION OF EXAMPLE EMBODIMENTS

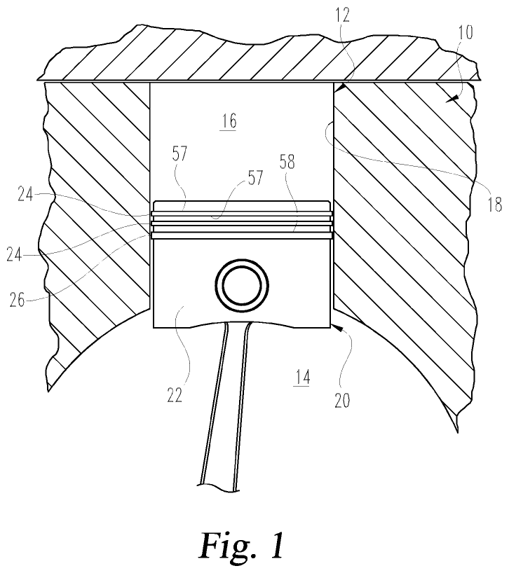

With reference to FIG. 1, an internal combustion engine 10 includes a cylinder 12 and a crankcase 14 below the cylinder 12. Cylinder 12 includes a combustion chamber 16. A cylinder bore wall 18 extends around the combustion chamber 16. Cylinder 12 includes a piston assembly 20 having a piston 22. The piston 22 is housed in the combustion chamber 16. The piston 22 includes a plurality of annular grooves 57, 58. Piston 22 reciprocates in the combustion chamber 16 along the bore wall 18 during operation of engine 10 to rotate a crankshaft (not shown).

Piston assembly 20 may include one or more piston rings 24 and an oil ring 26. The piston rings 24 project outwardly from piston 22 toward the bore wall 18. Each piston ring 24 is located in an annular groove 57 of the piston 22. The piston 22 also includes at least one annular groove 58 for oil ring 26. Oil ring 26 is positioned closest to the crankcase 14 (e.g., lower ring). Oil ring 26 is configured to wipe excess oil from the bore wall 18 as the piston 22 travels up and down in the cylinder 12.

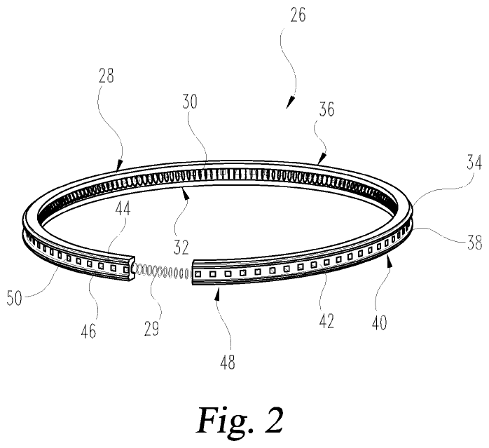

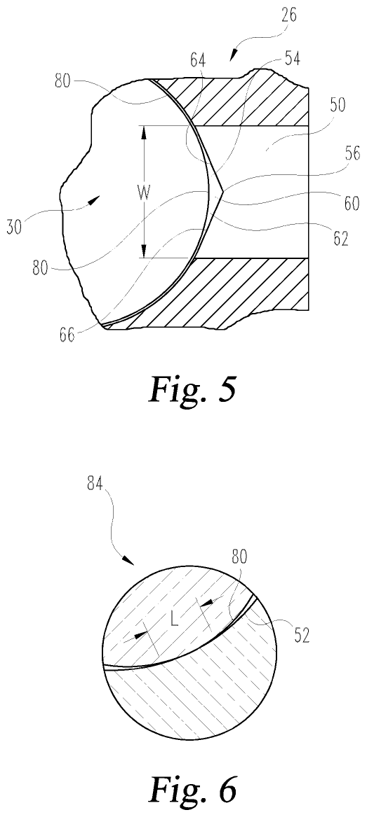

Referring further to FIGS. 2-6, an embodiment of oil ring 26 for piston 22 of internal combustion engine 10 is disclosed. Oil ring 26 includes an oil ring body 28 having a cross section viewed in an axial direction. The cross section of oil ring body 28 has an outer side 48 and an inner side 32. The oil ring body 28 further includes at least one drain hole 50 extending from the outer side 48 to the inner side 32. Oil ring 26 also includes an expander 30 having an outer surface 80, and the outer surface 80 contacts the inner side 32 of the oil ring body 28 at a first contact location 82 and a second contact location 84. An oil drain gap 54 is formed by the inner side 32 of the oil ring body 28 and the outer surface 80 of the expander 30 between the first contact location 82 and the second contact location 84. The oil drain gap 54 including a trough portion 56 that intersects the at least one drain hole 50.

In an embodiment, piston assembly 20 for internal combustion engine 10 is provided. The piston assembly 20 includes piston 22 including a plurality of annular grooves 58. At least one piston ring 24 is located in one of the plurality of grooves 58, and oil ring 26 is provided in another one of the plurality of grooves 58. The oil ring 26 includes oil ring body 28 with inner side 32 facing the piston 22 and opposite outer side 48. Expander 30 includes outer surface 80 in contact with the inner side 32 of the oil ring body 28 to radially expand the oil ring body 28. The outer surface 80 of the expander 30 contacts the oil ring body 28 at first contact location 82 and at second contact location 84, and second contact location 84 is circumferentially spaced from the first contact location 82. Oil drain gap 54 is formed between the inner side 32 of the oil ring body 28 and the outer surface 80 of the expander 30. The oil drain gap 54 extends from the first contact location 82 to the second contact location 84. The inner side 32 of the oil ring body 28 includes a channel 60 around inner side 32 that intersects the at least one drain hole 50 and forms trough portion 56 of the oil drain gap 54.

With reference to FIG. 2, there is illustrated oil ring 26 according to an example embodiment of the present disclosure. In FIG. 2, the oil ring 26 is C-shaped and includes oil ring body 28 with expander 30 arranged along inner side 32 of the oil ring body 28. In an embodiment, “C-shaped” is a substantially circular shape with a gap or opening through one side that is located between adjacent, facing ends of the oil ring body 28. In an embodiment, expander 30 is a coil expander with a spring-like body that expands radially outwardly when released from a radially contracted configuration, but other types of expanders are also contemplated in the present disclosure.

Referring further to FIG. 2, the oil ring body 28 includes a first rail 34 on an upper side 36 of the oil ring body 28 and a second rail 38 on a lower side 40 of the oil ring body 28. The first rail 34 and second rail 38 are integrally connected by a middle portion 42 and extend along the circumferential C-shaped direction of the oil ring body 28. Oil ring body 28 forms a gap 29 between adjacent ends of the oil ring body 28 that facilitates radial expansion of oil ring body 28 and drainage of excess oil from behind oil ring 26 in groove 58.

The first rail 34 includes a first projection 44 and the second rail 38 includes second projection 46. The first projection 44 and second projection 46 are configured to contact with bore wall 18 of cylinder 12. The first projection 44, second projection 46, and middle portion 42 define an outer side 48 of the oil ring body 28 facing the bore wall 18. First projection 44 and second projection 46 slide against the bore wall 18 as the piston 22 reciprocates up and down in cylinder 12. The middle portion 42 includes a plurality of oil drain holes 50 arranged about the perimeter of the oil ring body 28 in the middle portion 42.

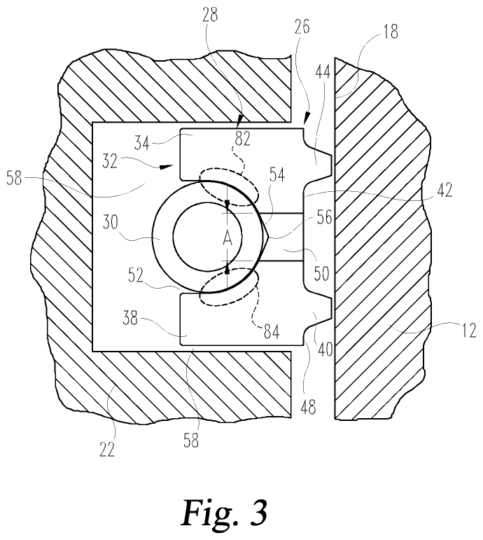

With reference to FIG. 3, there is illustrated a sectional view of the oil ring 26 including oil ring body 28 and expander 30. In particular, FIG. 3 illustrates piston 22 including a cross sectional view of oil ring 26 positioned in lower piston groove 58, and piston 22 positioned along a combustion chamber surface of bore wall 18 of cylinder 12. Outer side 48 of the oil ring body 28 includes first projection 44, second projection 46, and middle portion 42 extending between first projection 44 and second projection 46 and facing bore wall 18. Oil drain hole 50 is provided in the middle portion 42 and extends from outer side 48 to inner side 32 to provide drainage of excess oil collected between projections 44, 46.

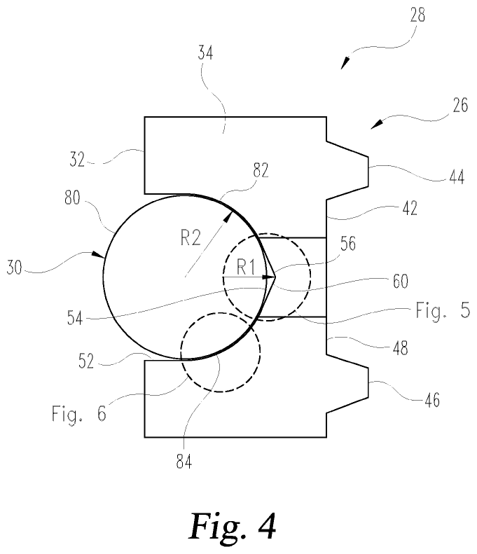

Referring further to FIGS. 4-6, inner side 32 of the oil ring body 28 includes a concave surface portion 52 having oil drain gap 54 fluidly coupled with oil drain hole 50. The concave surface portion 52 receives expander 30. Trough portion 56 of oil drain gap 54 is formed by channel 60 extending along inner side 32 in concave surface portion 52. The channel 60 extends continuously between and intersects each of the drain holes 50. It shall be appreciated that the expander 30 may be deformed to fit into the concave surface portion 52, and once positioned in the concave surface portion 52, is radially biased outwardly so that outer surface 80 of expander 30 is pressed against the oil ring body 28 at a first contact location 82 and second contact location 84.

In an embodiment, oil drain gap 54 includes a first side 62 along the outer surface 80 of the expander 30 that extends from the first contact location 82 to the second contact location 84. Oil drain gap 54 also includes a second side 64 along the concave surface portion 52 of inner side 32 of the oil ring body 28. The second side 64 extends from the first contact location 82 to the trough portion 56. Oil ring gap 54 also includes a third side 66 along the concave surface portion 52 of inner side 32 of the oil ring body 28. The third side 66 extends from the second contact location 84 to the trough portion 56, and the trough portion 56 connects the second side 64 and the third side 66.

In an embodiment, the second side 64 and the third side 66 of the oil drain gap 54 each have a first curvature formed by the concave surface portion 52 along the inner side 32 of the oil ring body 28. The trough portion 56 has a second curvature formed by the inner side 32 of the oil ring body 28. The first curvature is greater than the second curvature so that trough portion 56 provides channel 60 with additional volume for oil drain gap 54 at a location that bisects or is located in the middle of oil drain holes 50.

In an embodiment, the concave surface portion 52 of the oil ring body 28 includes a first concave curvature along the first and second contact locations 82, 84. The first concave curvature is defined by a first radius or radii of curvature R1. The concave curvature of concave surface portion 52 along the trough portion 56 is defined by a second radius or radii of curvature R2. The second radius of curvature R2 is greater than the first radius of curvature R1 such that trough portion 56 is more aggressively curved than second and third sides 64, 66. In an embodiment, the first radius curvature R1 extends along oil drain gap 54 from each of the first and second contact locations 82, 84 to the opposite sides of trough portion 56.

In an embodiment, the outer surface 80 of expander 30 includes a circumference. The first contact location 82 and the second contact location 84 each define a contact length L around the expander 80. In an embodiment, the total contact length (2L) provided by first and second contact locations 82, 84 occupies between 30% and 40% of the circumference has been found to provide a contact length that seats expander 30 against oil ring body 28 that improves retainment during handling of oil ring 26 and assembly with piston 22, while sldo providing sufficient clearance between expander 30 and body 28 to allow passage of oil in oil drain gap 54. In another embodiment, the total contact length 2L is between 33% and 37% of the circumference to improve retainment during handling of oil ring 26 and assembly of it with piston 22, while providing sufficient clearance to form oil drain gap 54. In still another embodiment, the total contact length 2L is 35% of the circumference to improve retainment during handling of oil ring 26 and assembly with piston 22, while providing sufficient clearance to form oil drain gap 54.

In an embodiment, the oil drain gap 54 has a width W along the outer surface 80 of the expander 30. Width W extends from the first contact location 82 to the second contact location 84. In an embodiment, width W ranges from 10% to 20% of the circumference of expander 30 to provide a sufficient clearance between expander 30 and oil ring body 28 for oil drainage to prevent oil blockage issues. In another embodiment, width W is 15% of the circumference of expander 30 to provide a sufficient clearance between expander 30 and oil ring body 28 for oil drainage to prevent oil blockage issues.

Oil drain hole 50 allows any excess oil to drain into oil drain gap 54, then into groove 58, and then from groove 58 back to an oil pan (not shown) located below piston 22.

Failure to maintain a clearance for the excess oil could cause oil blockage issues that can lead to increase oil consumption rates. In the example embodiment, trough 56 of oil drain gap 54 provides additional flow volume around oil ring 26 in communication with oil drain holes 50 for receipt of oil and to enable excess oil drainage without causing oil blockage.

Further, the configuration of first and second contact locations 82, 84 provides improved support and expander retainment to sufficiently maintain retain the expander 30 in engagement with the inner side 32 of the oil ring body 28, particularly during handling and assembly. In accordance with the above-described example embodiments, there is improved coil expander retainment which also provides assemble-ability benefits by enabling the expander 30 to seat against and be retained against the oil ring body 28. In addition, oil drain gap 54 enhances drainage of excess oil from the outer side 48 of oil ring body 28.

Further written description of a number of example embodiments shall now be provided. In one embodiment, an oil ring for a piston of an internal combustion engine is provided. The oil ring includes an oil ring body and an expander. The oil ring body has a cross-section viewed in an axial direction, and the cross section has an outer side and inner side. The oil ring body further includes at least one drain hole extending from the inner side to the outer side of the cross-section. The expander has an outer surface, and the outer surface contacts the inner side of the oil ring body at a first contact location and a second contact location. An oil drain gap is formed by the inner surface of the oil ring body and the outer surface of the expander between the first contact location and the second contact location, and the oil drain gap includes a trough portion that intersects the at least one drain hole.

In a further embodiment, the inner side of the oil ring body includes a concave surface along the first contact location and along the second contact location, and the outer surface of the expander includes a convex surface along the first contact location and along the second contact location.

In yet a further embodiment, the outer surface of the expander includes a circumference, and the first contact location and the second contact location together define a contact length around the expander that occupies between 30% and 40% of the circumference of the expander. In still a further embodiment, the contact length is between 33% and 37% of the circumference of the expander. In still a further embodiment, the contact length is 35% of the circumference of the expander.

In yet a further embodiment, the oil drain gap has a width along the outer surface of the expander from the first contact location to the second contact location, the width ranging from 10% to 20% of the circumference of the expander. In still a further embodiment, the width is 15% of the circumference.

In a further embodiment, the oil drain gap includes a first side along the outer surface of the expander that extends from the first contact location to the second contact location, a second side along the inner side of the oil ring body, the second side extending from the first contact location to the trough portion, and a third side along the inner side of the oil ring body, the third side extending from the second contact location to the trough portion. The trough portion connects the second side and the third side.

In yet a further embodiment, the second side and the third side of the oil drain gap each have a first radius of curvature formed by the inner side of the oil ring body, the trough portion has a second radius of curvature formed by the inner side of the oil ring body, and the second radius of curvature is greater than the first radius of curvature. In still a further embodiment, the trough portion bisects the at least one drain hole.

In a further embodiment, the inner side of the oil ring body includes a first concave curvature along the first and second contact locations, a second concave curvature along the trough portion, and the second concave curvature is greater than the first concave curvature so that the trough portion is more aggressively curved than the inner side of the oil ring body along the first and second contact locations. In yet a further embodiment, the inner side having the first concave curvature extends along the oil drain gap from each of the first and second contact locations to the trough portion.

In a further embodiment, the oil ring body includes a first projection and a second projection extending from the outer side, and the at least one drain hole is located between the first projection and the second projection.

According to another embodiment, a piston assembly for an internal combustion engine is provided. The piston assembly includes a piston including a plurality of annular grooves, at least one piston ring in one of the plurality of grooves, and an oil ring in another one of the plurality of grooves. The oil ring includes an oil ring body having an inner side facing the piston and an opposite outer side. The oil ring body including at least one drain hole extending between the inner side and the outer side. The oil ring also includes an expander including an outer surface in contact with the inner side of the oil ring body to radially expand the oil ring body. The outer surface of the expander contacts the oil ring body at a first contact location and at a second contact location that is circumferentially spaced from the first contact location. An oil drain gap is formed between the inner side of the oil ring body and the outer surface of the expander. The oil drain gap extends from the first contact location to the second contact location, and the inner side of the oil ring body includes a channel extending around the inner side that intersects the at least one drain hole and forms a trough portion of the oil drain gap.

In a further embodiment, the at least one drain hole includes a plurality of drain holes around the oil ring body, and the channel intersects each of the plurality of drain holes.

In a further embodiment, the inner surface has a first concave curvature along the first and second contact locations, and the first concave curvature extends from each of the first and second contact locations along the oil drain gap to the channel. In yet a further embodiment, the channel includes a second concave curvature, and the second concave curvature is more aggressively curved than the first concave curvature. In yet a further embodiment, the outer surface of the expander includes a convex curvature that extends along the oil drain gap, along the first contact location, and along the second contact location.

In a further embodiment, the outer surface of the expander includes a circumference, and the first contact location and the second contact location together define a contact length around the expander that occupies between 30% and 40% of the circumference.

In a further embodiment, the oil drain gap has a width along the outer surface of the expander from the first contact location to the second contact location, the width ranging from 10% to 20% of a circumference of the expander.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An oil ring for a piston of an internal combustion engine, the oil ring comprising:
an oil ring body having a cross-section viewed in an axial direction, the cross section having an outer side and inner side, the oil ring body further including at least one drain hole extending from the inner side to the outer side of the cross-section; and
an expander having an outer surface, the outer surface contacting the inner side of the oil ring body at a first contact location and a second contact location,
wherein an oil drain gap is formed by the inner surface of the oil ring body and the outer surface of the expander between the first contact location and the second contact location, the oil drain gap including a trough portion that intersects the at least one drain hole.

2. The oil ring of claim 1, wherein;
the inner side of the oil ring body includes a concave surface along the first contact location and along the second contact location; and
the outer surface of the expander includes a convex surface along the first contact location and along the second contact location.

3. The oil ring of claim 2, wherein the outer surface of the expander includes a circumference, and the first contact location and the second contact location together define a contact length around the expander that occupies between 30% and 40% of the circumference of the expander.

4. The oil ring of claim 3, wherein the contact length is between 33% and 37% of the circumference of the expander.

5. The oil ring of claim 3, wherein the contact length is 35% of the circumference of the expander.

6. The oil ring of claim 3, wherein the oil drain gap has a width along the outer surface of the expander from the first contact location to the second contact location, the width ranging from 10% to 20% of the circumference of the expander.

7. The oil ring of claim 6, wherein the width is 15% of the circumference.

8. The oil ring of claim 1, wherein the oil drain gap includes:
a first side along the outer surface of the expander that extends from the first contact location to the second contact location;
a second side along the inner side of the oil ring body, the second side extending from the first contact location to the trough portion; and
a third side along the inner side of the oil ring body, the third side extending from the second contact location to the trough portion, wherein the trough portion connects the second side and the third side.

9. The oil ring of claim 8, wherein:
the second side and the third side of the oil drain gap each have a first radius of curvature formed by the inner side of the oil ring body;
the trough portion has a second radius of curvature formed by the inner side of the oil ring body; and
the second radius of curvature is greater than the first radius of curvature.

10. The oil ring of claim 9, wherein the trough portion bisects the at least one drain hole.

11. The oil ring of claim 1, wherein the inner side of the oil ring body includes:
a first concave curvature along the first and second contact locations;
a second concave curvature along the trough portion; and
the second concave curvature is greater than the first concave curvature so that the trough portion is more aggressively curved than the inner side of the oil ring body along the first and second contact locations.

12. The oil ring of claim 11, wherein the inner side having the first concave curvature extends along the oil drain gap from each of the first and second contact locations to the trough portion.

13. The oil ring of claim 1, wherein the oil ring body includes a first projection and a second projection extending from the outer side, and the at least one drain hole is located between the first projection and the second projection.

14. A piston assembly for an internal combustion engine, the piston assembly comprising:
a piston including a plurality of annular grooves;
at least one piston ring in one of the plurality of grooves; and
an oil ring in another one of the plurality of grooves, the oil ring including:
an oil ring body having an inner side facing the piston and an opposite outer side, the oil ring body including at least one drain hole extending between the inner side and the outer side; and
an expander including an outer surface in contact with the inner side of the oil ring body to radially expand the oil ring body, the outer surface of the expander contacting the oil ring body at a first contact location and at a second contact location that is circumferentially spaced from the first contact location, wherein an oil drain gap is formed between the inner side of the oil ring body and the outer surface of the expander, the oil drain gap extending from the first contact location to the second contact location, and the inner side of the oil ring body includes a channel extending around the inner side that intersects the at least one drain hole and forms a trough portion of the oil drain gap.

15. The piston assembly of claim 14, wherein:
the at least one drain hole includes a plurality of drain holes around the oil ring body; and
the channel intersects each of the plurality of drain holes.

16. The piston assembly of claim 14, wherein the inner surface has a first concave curvature along the first and second contact locations, and the first concave curvature extends from each of the first and second contact locations along the oil drain gap to the channel.

17. The piston assembly of claim 16, wherein the channel includes a second concave curvature, and the second concave curvature is more aggressively curved than the first concave curvature.

18. The piston assembly of claim 16, wherein the outer surface of the expander includes a convex curvature that extends along the oil drain gap, along the first contact location, and along the second contact location.

19. The piston assembly of claim 14, wherein the outer surface of the expander includes a circumference, and the first contact location and the second contact location together define a contact length around the expander that occupies between 30% and 40% of the circumference.

20. The piston assembly of claim 14, wherein the oil drain gap has a width along the outer surface of the expander from the first contact location to the second contact location, the width ranging from 10% to 20% of a circumference of the expander.
